(19) United States
(12) Patent Application Publication
(10) Pub. No.: US 2017/0130832 A1
(43) Pub. Date: May 11, 2017

(54) SHIFT SYSTEM WITH ON DEMAND LUBE AND MECHANICAL ECO VALVE

(71) Applicant: BorgWarner Inc., Auburn Hills, MI (US)

(72) Inventors: Larry A. PRITCHARD, Macomb, MI (US); Thaddeus R. KOPP, Oakland Township, MI (US)

(21) Appl. No.: 15/333,438

(22) Filed: Oct. 25, 2016

Related U.S. Application Data
(60) Provisional application No. 62/251,419, filed on Nov. 5, 2015.

(51) Int. Cl. F16H 61/32; F16H 57/04

(52) U.S. Cl. CPC F16H 61/32; F16H 57/0441; F16H 57/0435; F16H 2061/2869

(57) ABSTRACT

A number of variations may include a product that may include a motor, and may include a gear train driven by the motor. A shift mechanism may be engaged with the gear train. A valve may be engaged with the gear train. Selective rotation of the motor may simultaneously move the shift mechanism between a number of shift positions corresponding to operational modes of the product and may move the valve between a number of valve positions that may correspond to open or closed states of the valve.

### CROSS-REFERENCE TO RELATED APPLICATIONS

This application claims the benefit of U.S. Provisional Application No. 62/251,419 filed Nov. 5, 2015.

### TECHNICAL FIELD

The field to which the disclosure generally relates includes shift systems and more particularly, includes shift systems for power transfer units.

### BACKGROUND

Vehicle drive systems may include a combustion engine, electric motor or other power plant for propulsion. Hybrid vehicles may include a combination of different types of power plants. A power transfer unit may convey power from a drive system's motive source to wheels for propulsion.

### SUMMARY OF ILLUSTRATIVE VARIATIONS

According to a number of illustrative variations, a product may include a motor, and may include a gear train driven by the motor. A shift mechanism may be engaged with the gear train. A valve may be engaged with the gear train. Selective rotation of the motor may simultaneously move the shift mechanism between a number of shift positions corresponding to operational modes of the product and may move the valve between a number of valve positions that may correspond to open or closed states of the valve

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a product showing a system according to a number of variations.

FIG. 2 is a schematic illustration of part of the product of FIG. 1 showing a shift mechanism in a low range position.

FIG. 3 is a schematic illustration of part of the product of FIG. 1 showing a shift mechanism in a neutral position.

FIG. 4 is a schematic illustration of part of the product of FIG. 1 showing a shift mechanism in a high range position.

FIG. 5 is a schematic illustration of part of the product of FIG. 1 showing an engagement mechanism in an engaged condition.

FIG. 6 is a schematic illustration of part of the product of FIG. 1 showing an engagement mechanism in a disengaged condition.

FIG. 7 is a schematic illustration of part of the product of FIG. 1 showing a valve in a closed state.

FIG. 8 is a schematic illustration of part of the product of FIG. 1 showing a valve in an open state.

FIG. 9 is a schematic illustration of part of the product of FIG. 1 showing a valve in another open state.

FIG. 10 is a schematic illustration of a product showing a drive system according to a number of variations.

### DETAILED DESCRIPTION OF ILLUSTRATIVE VARIATIONS

The following description of the variations is merely illustrative in nature and is in no way intended to limit the scope of the invention, its application, or uses.

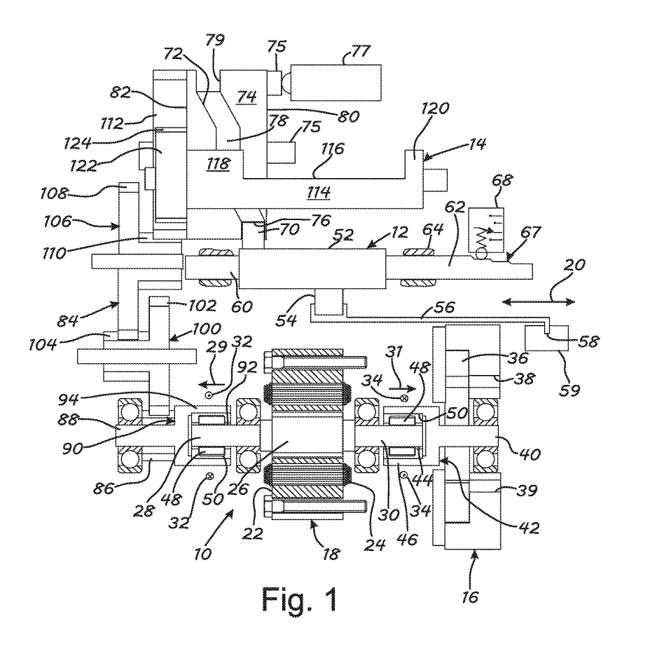

In a number of variations as illustrated in FIG. 1 a product 10 may generally include a shift mechanism 12, a valve 14, a fluid pump 16, and a motor 18. The shift mechanism 12 may include a linearly translating device that may provide bi-directional output 20 in response to rotational input from the motor 18. The valve 14 may be a rotary valve that may provide a variable flow path, such as to supply lubrication to an associated system at different flow rates and may close the flow path. The valve may 14 may open to supply lubrication when needed and may be closed to contain lubricant when not needed, which may minimize churning losses of the lubricated components. The fluid pump 16 may be used to supply an on-demand flow of a fluid such as a lubricant for the associated system. The motor 18 may drive the pump 16, and/or may drive the valve 14, and/or may drive the shift mechanism 12.

In a number of variations the motor 18 may operate on electric, fluid, mechanical or other principles. In a number of variations the motor 18 may be a brushless DC motor. The motor 18 may be frequently stopped in defined angular positions, may exhibit stopped holding torque, and may be entirely enclosed for use in environments where fluid is present. The motor 18 may include a stator 22 with a number of windings 24 for selectively generating a magnetic field when energized. The motor 18 may be reversible, such as by changing the commutation order of the windings 24. The motor 18 may include a rotor 26 that may be positioned within the stator 22 and may rotate in response to energization of the coils 24. In a number of variations the rotor 26 may include a first shaft 28 that may extend from the rotor 26 in a first direction 29 and may include a second shaft 30 that may extend from the rotor 26 in a second direction 31 that is opposite the first direction 29. The shafts 28, 30 may be integrated with each other, and/or may be connected to the rotor 26, or may be integrally formed therewith. The motor 18 may be operated in a first rotational direction 32 wherein the shaft 28 rotates so that its top (as viewed in FIG. 1), moves toward the viewer and its bottom (as viewed in FIG. 1), moves away from the viewer. The motor 18 may be operated in a second rotational direction 34 wherein the shaft 30 rotates so that its top (as viewed in FIG. 1), moves away from the viewer and its bottom (as viewed in FIG. 1), moves toward the viewer. As will be understood, the shafts 28, 30 may rotate together in the same rotational direction with the rotor 26, whether it be rotational direction 32 or 34.

In a number of variations the pump 16 may be driven by the motor 18 in only one of the rotational directions 32, 34. For example, the pump may include an impeller 36 that may be supported on a pump shaft 40. For example, the impeller 36 may be driven to rotate by the motor 18 when operating. When rotating, the impeller 36 may pump a fluid through a known mechanism, such as through the use of moving vanes, such as may be employed in a rotary vane pump. In other variations another type of pump may be used. The pump 16 may include an inlet 38 through which fluid may be drawn into the pump 16 and may include an outlet 39 through which fluid may be delivered out of the pump 16 under increased pressure. The pump 16 may deliver fluid for any number of uses. In a number of variations the pump 16 may deliver a fluid lubricant such as may be used to lubricate moving gears, shafts and other mechanical or electric mechanisms, such as in a power transfer unit 59.

In a number of variations rotation of the pump 16 may be limited to one of the rotational directions 32, 34 by the use of an engagement mechanism 42. The engagement mechanism 42 may provide selective or one-directional engagement between the motor shaft 30 and the pump shaft 40. In a number of variations the engagement mechanism 42 may be a one-way clutch that may include a first race 44 that may rotate with the motor shaft 30. A second race 46 may rotate with the pump shaft 40. A number of locking elements 48 may be positioned between the races 44, 46. In a number of variations the locking elements 48 may be rollers that may lock the races 44, 46 to rotate together in one of the rotational directions 32, 34, and that may release the races 44, 46 to rotate relative to each other in the other of the rotational directions 32, 34. As one skilled in the art would understand, one of the races 44, 46 may include pockets 50 in which the locking elements 48 may be positioned and may include springs 97 (shown in FIGS. 5 and 6), that may bias the locking elements 48 to lock the races 44, 46 in one of the rational directions 32, 34 as shown in FIG. 5, and to unlock the races 44, 46 in the other of the rotational directions 32, 34, as shown in FIG. 6. In a number of variations the engagement mechanism 42 may lock the races 44, 46 in the second rotational direction 34 so that the impeller 36 rotates with the rotor 26, and may unlock the races 44, 46 in the first rotational direction 32 so that the impeller 36 may remain stationary as the rotor 26 rotates.

In a number of variations, in one of the rotational directions 32, 34, the motor 18 may drive the shift mechanism 12. For example, while the impeller 36 may remain stationary, the shift mechanism 12 may be driven by the motor 18 when operating in the first rotational direction. In a number of variations the shift mechanism 12 may include a follower 52 that may translate linearly to effect the bi-directional output 20. A shift stud 54 may be connected to, or formed with, the follower 52 and may effect shifts between multiple operating states such as a high range, a low range and neutral in a powered system. The shift stud 54 may be engaged in a shift arm 56 to transfer movement of the follower 52 to a remote shift effector 58, or may directly engage with a local shift effector at the shift stud 54. The shift effector 58 may effect shifts between operational modes of a power transfer unit 59, such as may be used in a vehicle drive train to drive the vehicle's wheels. An exemplary power transfer unit is disclosed in U.S. patent application Ser. No. 14/824,724 titled Eco Mode E-Assist, filed on Aug. 12, 2015, which issued on Aug. 9, 2016 as U.S. Pat. No. 9,410,610, which is assigned to the assignee of this application, and which is specifically incorporated herein by reference. In a number of variations the shift effector 58 may be a cone clutch or other type of synchronizer capable of matching rotating speeds. In a number of variations the product 10 may be carried in a common housing 64 with the power transfer unit 59. In a number of variations the follower 52 may be mounted on, or may include, a shaft or shafts 60, 62, which may be slidably supported on the housing 64. The shaft 62 may include a stepped section 67 that may be engaged by a position switch 68 to monitor the position of the follower 52, as an indication of the mode to which the power transfer unit 59 is shifted.

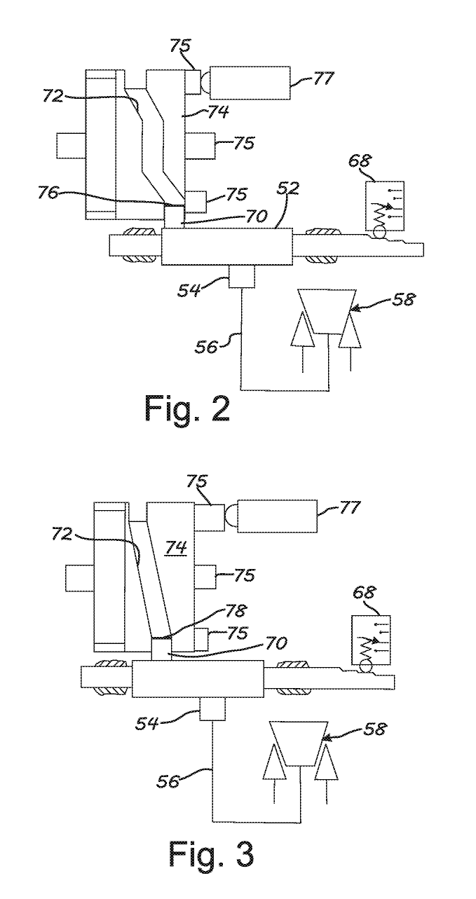

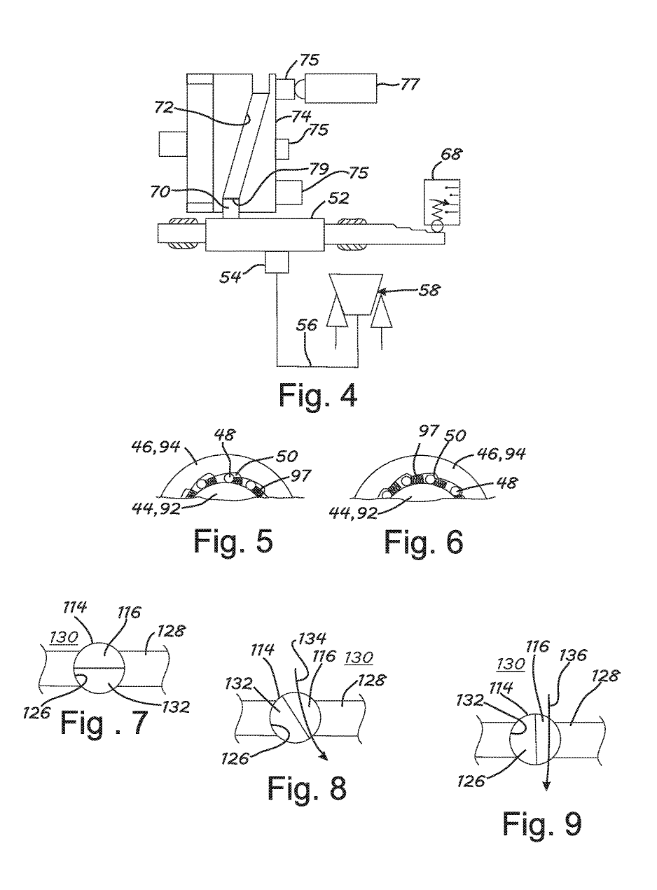

The follower 52 may include a follower stud 70 that may be engaged in a cam channel 72 of a cam 74. Rotation of the cam 74 may cause the follower 52 to translate and to effect the bi-directional output 20 as the follower stud moves into a first segment 76, a second segment 78 or a third segment 79, of the cam channel 72. The first segment 76 may be nearer to a side 80 of the cam 74 than is the second segment 78. The third segment 79 may be nearer to an opposite side 82 of the cam 74 than is the second segment 78. For example, the follower stud 70 may be positioned in the first segment 76 where the follower 52 may be positioned to the right as shown in FIG. 1. This may position the shift effector 58 so that the connected power transfer unit 59 is placed in a low range mode of operation as is also illustrated in FIG. 2 (viewed with the valve 14 omitted). In a number of variations the cam 74 may be rotated by the motor 18 to move the follower stud 70 into the second segment 78 as shown in FIG. 3 (viewed with the valve 14 omitted). This may position the shift effector 58 so that the connected power transfer unit 59 is placed in neutral. In a number of variations the cam 74 may be rotated by the motor 18 to move the follower stud 70 into the third segment 79 as shown in FIG. 4 (viewed with the valve 14 omitted). This may position the shift effector 58 so that the connected power transfer unit 59 is placed in a high range mode of operation. In a number of variations a different number of modes of operation may be provided by providing a different number of segments to the cam channel 72. The cam 74 may include a number of projections 75, each of which may correspond to a segment of the cam channel 72. The projections 75 may extend from the cam 74 at various lengths and a position sensor 77 may be used to determine the position of the cam 74 through registry with alternate projections 75.

In a number of variations the cam 74 may be rotated by the motor 18 through a gear train 84. A first gear 86 of the gear train 84 may be connected with a shaft 88 that is supported for rotation. An engagement mechanism 90 may be provided between the gear shaft 88 and the motor shaft 28. The engagement mechanism 90 may provide selective or one-directional engagement between the motor shaft 28 and the gear shaft 88. In a number of variations the engagement mechanism 90 may be a one-way clutch that may include a first race 92 that may rotate with the motor shaft 28. A second race 94 may rotate with the gear shaft 88. A number of locking elements 48 may be positioned between the races 92, 94. In a number of variations the locking elements 48 may be rollers that may lock the races 92, 94 to rotate together in one of the rotational directions 32, 34, and that may release the races 92, 94 to rotate relative to each other in the other of the rotational directions 32, 34. One of the races 92, 94 may include pockets 50 in which the locking elements 48 may be positioned and may include springs 97, that may bias the locking elements 48 to lock the races 92, 94 as shown in FIG. 5, in one of the rational directions 32, 34 and to unlock the races 92, 94 as shown in FIG. 6, in the other of the rotational directions 32, 34. In a number of variations the engagement mechanism 90 may lock the races 92, 94 in the first rotational direction 32 so that the gear 86 rotates with the rotor 26, and may unlock the races 92, 94 in the second rotational direction 34 so that the gear 86 remains stationary as the rotor 26 rotates, such as to drive the impeller 36.

In a number of variations the gear 86 may be engaged with a stepped gear 100 that may have a first gear 102 and a second gear 104 that may rotate together. The first gear 102 may have a larger diameter and a greater number of teeth than the second gear 104. The teeth of the first gear 102 may mesh with the teeth of the gear 86 so that the stepped gear 100 may be driven by the gear 86. The stepped gear 100 may be engaged with another stepped gear 106 that may have a first gear 108 and a second gear 110 that may rotate together. The first gear 108 may have a larger diameter and a greater number of teeth than the second gear 110. The teeth of the first gear 108 may mesh with the teeth of the second gear 104 so that the stepped gear 106 may be driven by the stepped gear 100. The second gear 110 may be engaged with a gear 112 that may be fixed to the cam 74 to rotate therewith. Through the gear train 84, the gear 86 may drive the steeped gear 100, which may drive the stepped gear 106, which may drive the gear 112 and the cam 74. When the motor 18 may be operated in the first rotational direction 32, it may drive the gear 86 through the engagement mechanism 90, wherein the races 92, 94 are locked to rotate together. Through the gear train 84, the motor 18, when driven in the first rotational direction 32, may drive the cam 74 to rotate, while the impeller 36 may remain stationary. The motor 18, when driven in the second rotational direction, may drive the impeller 36 to rotate, while the cam 74 may remain stationary. In a number of variations the rotational directions that drive the cam 74 and the impeller 36 may be switched.

In a number of variations the gear train 84 may drive the valve 14 to rotate. The valve 14 may be a rotary valve that may include a body 114 that may be formed in the shape of a solid cylinder and that may have a section removed to form a valley 116 between a pair of lands 118, 120. The valley 116 may provide a variable flow path for the flow of a fluid. The body 114 may be connected to rotate with a gear 122. The gear 122 may include teeth 124 that may mesh with the teeth of the gear 112 so that the body 114 rotates with the gear train 84. In a number of variations the body 114 may be disposed in a bore 126 of a platform 128 as shown in FIGS. 7-9, that may be a part of the housing 64. The platform 128 may define a reservoir 130 that may capture and contain fluid. For example, in a unit of a drive system such as the power transfer unit 59, the reservoir 130 may receive splash oil during operation, and may hold the oil when the body is positioned in a closed position as shown in FIG. 7. The reservoir 130 may hold oil when the power transfer unit 59 is in neutral as effected by the shift mechanism 12. The gears 112, 124 and the cam channel 72 may be designed so that when the shift mechanism 12 places the shift effector 58 in neutral, the body 114 may be positioned so that its stem 132 closes the bore 126. Retaining the oil in the reservoir 130 may reduce spin losses when a lower level of lubrication is needed in the power transfer unit 59. Releasing oil from the reservoir 130 may provide additional lubrication or cooling when needed.

In a number of variations the electric motor 18 may drive the shift mechanism to move the shift effector 58 to shift to a high range mode of operation of the power transfer unit 59. Concurrently, the electric motor 18 may drive the body 114 to turn in the bore 126 and to open a flow path 134 through the platform 128 as shown in FIG. 8. The gears 112, 124 and the cam channel 72 may be designed so that when the shift mechanism 12 places the shift effector 58 in a high mode position, the body 114 may be positioned so that its valley 116 opens the bore 126. The flow path 134 may provide a low rate of flow as needed such as when the power transfer unit 59 may be operating in the high mode which may be associated with low load and torque.

In a number of variations the electric motor 18 may drive the shift mechanism to move the shift effector 58 to shift to a low range mode of operation. Concurrently, the electric motor 18 may drive the body 114 to turn in the bore 126 and to open a flow path 136 through the platform 128 as shown in FIG. 9. The gears 112, 124 and the cam channel 72 may be designed so that when the shift mechanism 12 places the shift effector 58 in a low mode position, the body 114 is positioned so that its valley 116 opens the bore 126. The flow path 136 may provide a rate of flow that is greater than the rate of flow through the flow path 134 such as may be needed when the power transfer unit 59 is operating in the low mode which may be associated with higher load and torque. As the shift mechanism 12 and the valve 14 are repositioned by the motor 18, the pump 16 may be temporarily non-rotating as the mode shift is carried out. The motor 18 may drive the pump 16 as desired when the mode shift is complete, and regardless of whether the system is operating in high, low or neutral. The motor 18 may be stopped when not needed to conserve power.

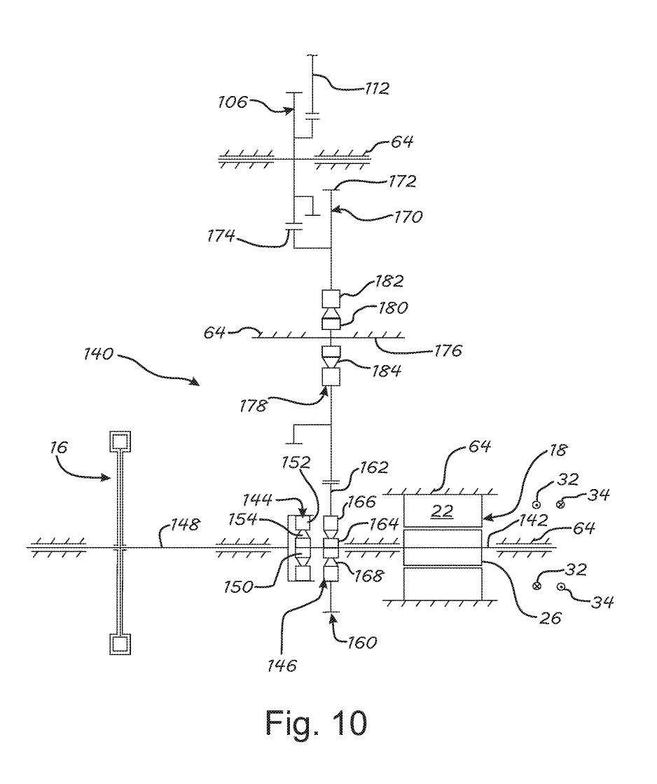

In a number of variations as illustrated in FIG. 10, the pump 16 and/or the stepped gear 106 may be driven by a drive system 140. The drive system 140 may include the motor 18, which may have the stator 22 that may be fixed to the housing 64. The rotor 26 may be rotationally fixed to a shaft 142, the rotation of which, may be effected by the motor 18. The shaft 142 may be journaled on the housing 64, or supported thereon by bearings for example, such as shown in FIG. 1. The motor 18 may be operated to selectively rotate the shaft 142 in either rotational direction 32, 34. The shaft 142 may be engaged with a pair on engagement mechanisms 144, 146. The engagement mechanism 144 may provide selective or one-directional engagement between the shaft 142 and the pump shaft 148. In a number of variations the engagement mechanism 144 may be a one-way clutch that may include a first race 150 that may rotate with, or may be formed with, the motor shaft 142. A second race 152 may rotate with, or may be formed with, the pump shaft 148. A number of locking elements 154 may be positioned between the races 150, 152. In a number of variations the locking elements 154 may lock the races 150, 152 to rotate together in one of the rotational directions 32, 34, and that may release the races 150, 152 to rotate relative to each other in the other of the rotational directions 32, 34. As a result, the pump 16 may be driven to generate pressure in one rotational direction of the motor 18, but not in the other rotational direction. The engagement mechanism 146 may provide selective or one-directional engagement between the shaft 142 and a gear train 160 such as at a gear 162. In a number of variations the engagement mechanism 146 may be a one-way clutch that may include a first race 164 that may rotate with, or may be formed with, the motor shaft 142. A second race 166 may rotate with, or may be formed with, the gear 162. A number of locking elements 168 may be positioned between the races 164, 166. In a number of variations the locking elements 168 may lock the races 164, 166 to rotate together in one of the rotational directions 32, 34, and that may release the races 164, 166 to rotate relative to each other in the other of the rotational directions 32, 34. As a result, the gear train 160 may be driven in one rotational direction of the motor 18, but not in the other rotational direction. The rotational direction in which the engagement mechanism 144 effects driving of the pump 16 by the motor 18 may be the opposite direction compared to the rotational direction in which the engagement mechanism 146 effects driving of the gear train 160 by the motor 18.

In a number of variations the gear 162 may mesh with a gear 170 which may be a stepped gear that may have a first gear 172 and a second gear 174 that may rotate together. The first gear 172 may have a larger diameter and a greater number of teeth than the second gear 174. The first gear 172 may mesh with the gear 162. The gear 170 may be supported on a shaft 176 that may be fixed to the housing 64 and may be nonrotating relative thereto. In a number of variations an engagement mechanism 178 may be disposed between the shaft 176 and the gear 170. The engagement mechanism 178 may provide selective or one-directional engagement between the shaft 176 and the gear 170. In a number of variations the engagement mechanism 178 may be a one-way clutch that may include a first race 180 that may be fixed to, or formed with the shaft 176. A second race 182 may rotate with, or may be formed with, the gear 170. A number of locking elements 184 may be positioned between the races 180, 182. In a number of variations the locking elements 184 may lock the races 180, 182 together in one of the rotational directions 32, 34, and may release the races 180, 182 to rotate relative to each other in the other of the rotational directions 32, 34. As a result, the gear 170 may freely rotate on the shaft 176 in one rotational direction and may be locked to the housing 64 in the other rotational direction through the engagement mechanism 178 and the shaft 176. The engagement mechanism 178 may hold the gear 170 from rotating when the motor 18 is driving the pump 16 to generate pressure, which may also hold the gear 162. As a result, drag may be reduced or eliminated and the efficiency of the system 140 may be maximized. In a number of variations, the gear 170 may mesh with the gear 106 to drive the gear 112 for example, to effect the operations described in relation to FIGS. 1-9. The engagement mechanisms 146, 178 may be configured so that when the motor 18 is operated to drive the gear train 160, the gear 162 rotates with the shaft 142 and the gear 170 freely rotates on the shaft 176 to drive the gear 106. In addition, when the motor 18 is operated to drive the pump 16 to generate pressure, the engagement mechanism 146 may allow the shaft 142 to rotate relative to the gear 162, and the gear 170 may be fixed relative to the shaft 176, which may also hold the gear 162 from rotating to reduce losses.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve a product may include a differential unit, and an electrical machine may be interconnected with the differential unit. The differential unit and the electrical machine may be lubricated by a fluid. A reservoir may be defined above the electrical machine. The reservoir may receive the fluid during operation of the differential unit and may selectively store and release the fluid.

Variation 2 may include the product according to variation 1 wherein the valve may include a body that may rotate in response to rotation of the motor. The shift mechanism may include a follower that may move linearly in response to rotation of the motor.

Variation 3 may include the product according to variation 1 or 2 and may include a pump that may be connected to the motor. Selective rotation of the motor may rotate the pump.

Variation 4 may include the product according to variation 3 wherein the motor may rotate in a first rotational direction and in a second rotational direction reverse of the first rotational direction. The motor may drive the gear train in the first rotational direction but not in the second rotational direction.

Variation 5 may include the product according to variation 4 wherein the motor drives the pump in the second rotational direction but not in the first rotational direction.

Variation 6 may include the product according to variation 5 and may include a first engagement mechanism that may be connected between the motor and the gear train. A second engagement mechanism may be connected between the motor and the pump. The first engagement mechanism may rotationally engage the motor with the gear train in the first rotational direction. The second engagement mechanism may rotationally engage the motor with the pump in the second rotational direction.

Variation 7 may include the product according to variation 6 wherein the first engagement mechanism may rotationally disengage the motor from the gear train in the second rotational direction. The second engagement mechanism may rotationally disengages the motor from the pump in the first rotational direction.

Variation 8 may include the product according to any of variations 1 through 7 and may include a housing with a platform that defines a bore. The valve may include a body disposed in the bore. The body may selectively close the bore. The body may include a valley through which an opening may be selectively provided through the platform.

Variation 9 may include the product according to any of variations 1 through 8 and may include a cam defining a cam channel. A gear may be connected with the cam and may be engaged in the gear train. The shift mechanism may include a follower stud that may be engaged in the cam channel.

Variation 10 may involve a product that may include a motor that may be reversible to operate in a first rotational direction and in a second rotational direction that is opposite the first rotational direction. A gear train may be engaged with the motor and may be driven by the motor when operating in the first rotational direction. A shift mechanism may be engaged with the gear train and may be shiftable between a number of positions when the motor operates in the first rotational direction. A pump may pump a fluid when the motor operates in the second rotational direction.

Variation 11 may include the product according to variation 10 and may include a valve that may be engaged with the gear train and that may be rotatable between a number open and closed states when the motor operates in the first rotational direction.

Variation 12 may include the product according to variation 11 and may include a cam that may be connected between the gear train and the shift mechanism.

Variation 13 may include the product according to variation 11 and may include a shift effector. The shift mechanism may include a follower connected between the cam and the shift effector. The follower may translate linearly in response to operation of the motor in the first rotational direction.

Variation 14 may include the product according to variation 11 and may include a first engagement mechanism that may be connected between the motor and the gear train. A second engagement mechanism may be connected between the motor and the pump. The first engagement mechanism may rotationally engage the motor with the gear train in the first rotational direction. The second engagement mechanism may rotationally engage the motor with the pump in the second rotational direction. The first engagement mechanism may rotationally disengage the motor from the gear train in the second rotational direction. The second engagement mechanism may rotationally disengage the motor from the pump in the first rotational direction.

Variation 15 may involve a product that may include a motor that may have a rotor. A first shaft may extend from the rotor. A second shaft may extend from the rotor. A gear train may be engageable with the first shaft. A pump may be engageable with the second shaft. A shift mechanism may be engaged with the gear train. A power transfer unit may be included. The shift mechanism may effect shifts between modes of operation of the power transfer unit. A valve may be engaged with the gear train. The valve may control a flow of lubricant to the power transfer unit.

What is claimed is:

1. A product comprising a motor, a gear train driven by the motor, a shift mechanism engaged with the gear train and a valve engaged with the gear train, wherein selective rotation of the motor simultaneously moves the shift mechanism between a number of shift positions corresponding to operational modes of the product and moves the valve between a number of valve positions corresponding to open or closed states of the valve.

2. The product according to claim 1 wherein the valve includes a body that rotates in response to rotation of the motor and the shift mechanism includes a follower that moves linearly in response to rotation of the motor.

3. The product according to claim 1 further comprising a pump connected to the motor and wherein selective rotation of the motor rotates the pump.

4. The product according to claim 3 wherein the motor rotates in a first rotational direction and in a second rotational direction reverse of the first rotational direction, and the motor drives the gear train in the first rotational direction but not in the second rotational direction.

5. The product according to claim 4 wherein the motor drives the pump in the second rotational direction but not in the first rotational direction.

6. The product according to claim 5 further comprising a first engagement mechanism connected between the motor and the gear train and a second engagement mechanism connected between the motor and the pump, wherein the first engagement mechanism rotationally engages the motor with the gear train in the first rotational direction and the second engagement mechanism rotationally engages the motor with the pump in the second rotational direction.

7. The product according to claim 6 wherein the first engagement mechanism rotationally disengages the motor from the gear train in the second rotational direction and the second engagement mechanism rotationally disengages the motor from the pump in the first rotational direction.

8. The product according to claim 1 further comprising a housing with a platform that defines a bore, wherein the valve includes a body disposed in the bore, the body selectively closing the bore, the body includes a valley through which an opening is selectively provided through the platform.

9. The product according to claim 1 further comprising a cam defining a cam channel and a gear connected with the cam and engaged in the gear train, the shift mechanism including a follower stud engaged in the cam channel.

10. A product comprising a motor that is reversible to operate in a first rotational direction and a second rotational direction that is opposite the first rotational direction, a gear train engaged with the motor and driven by the motor when operating in the first rotational direction, a shift mechanism engaged with the gear train and shiftable between a number of positions when the motor operates in the first rotational direction, and a pump that pumps a fluid when the motor operates in the second rotational direction.

11. The product according to claim 10 further comprising a valve engaged with the gear train and rotatable between a number open and closed states when the motor operates in the first rotational direction.

12. The product according to claim 11 further comprising a cam connected between the gear train and the shift mechanism.

13. The product according to claim 11 further comprising a shift effector, wherein the shift mechanism includes a follower connected between the cam and the shift effector, the follower translating linearly in response to operation of the motor in the first rotational direction.

14. The product according to claim 11 further comprising a first engagement mechanism connected between the motor and the gear train and a second engagement mechanism connected between the motor and the pump, wherein the first engagement mechanism rotationally engages the motor with the gear train in the first rotational direction and the second engagement mechanism rotationally engages the motor with the pump in the second rotational direction, wherein the first engagement mechanism rotationally disengages the motor from the gear train in the second rotational direction and the second engagement mechanism rotationally disengages the motor from the pump in the first rotational direction.

15. A product comprising a motor that has a rotor with a first shaft extending from the rotor and a second shaft extending from the rotor, a gear train engageable with the first shaft, a pump engageable with the second shaft, a shift mechanism engaged with the gear train, a power transfer unit, the shift mechanism effecting shifts between modes of operation of the power transfer unit, and a valve engaged with the gear train, the valve controlling a flow of lubricant to the power transfer unit.
